(19) United States
(12) Patent Application Publication
(10) Pub. No.: US 2022/0058719 A1
(43) Pub. Date: Feb. 24, 2022

(54) ECOMMERCE MARKETPLACE WITH AUTOMATIC IDENTIFICATION OF CUSTOMER AS ASSOCIATED WITH A THIRD-PARTY SYSTEM

(71) Applicant: Amazon Technologies, Inc., Seattle, WA (US)

(72) Inventors: Vikash Kumar Jain, Hyderabad (IN); Ankur Anand, Hyderabad (IN); Satya S. Mishra, Redmond, WA (US); Neha Goswami, Bellevue, WA (US)

(73) Assignee: Amazon Technologies, Inc., Seattle, WA (US)

(21) Appl. No.: 17/115,247

(22) Filed: Dec. 8, 2020

Related U.S. Application Data
(60) Provisional application No. 63/068,924, filed on Aug. 21, 2020.

(51) Int. Cl. G06Q 30/06; H04L 29/06

(52) U.S. Cl. CPC G06Q 30/0637; G06Q 30/0609; H04L 63/0884; H04L 63/0853; H04L 63/102

(57) ABSTRACT

A system is disclosed allowing a customer to directly build a shopping cart on a supplier's website without logging into a third-party eProcurement system for which the customer is making purchases. Various push and pull models are used for allowing the customer to request content of shopping cart. After the customer logs into the supplier's website, the customer can be identified as associated with the third-party eProcurement system. In such a case, the user is displayed a control allowing the shopping cart to be transmitted to the third-party system for approval.

### CROSS REFERENCE TO RELATED APPLICATION

This application claims priority from U.S. Provisional Application No. 63/068,924, filed on Aug. 21, 2020, which application is incorporated herein by reference in its entirety.

### BACKGROUND

In a business-to-business (B2B) eCommerce context, business customers often use online supplier marketplaces to purchase products directly from other businesses or the B2B goods suppliers. For example, businesses can purchase office supplies, manufacturing parts, janitorial supplies, and other products directly from other businesses. B2B customers often use their home grown or 3P procurement systems (also referred to as eProcurement systems, spend management systems, punchout systems, supplier management portals, travel & expense management systems, etc.) to manage such procurement needs. Such systems are integrated with the supplier's marketplace to allow their employees or authorized users of the procurement systems to make purchases from the supplier's marketplace through such procurement systems. The use of such systems allows for greater visibility and control into the organization's purchases and for compliance with internal policies of the businesses.

For example, users can log into the 3P procurement system, then via links in the 3P system (e.g., via a click button), login into the supplier's marketplace (e.g., supplier system). Once they are on the supplier marketplace, the user then searches for the items to buy and builds a shopping cart of these items. This method of accessing a supplier's web-catalog, eCommerce website, or marketplace from within the B2B customer's procurement system is often referred to as “Punchout.” Once a customer “punches out” and builds the cart on the supplier's website, the user then transfers the cart back to their procurement system. Thus, the customer's employees can access and shop in an eCommerce website without leaving the customer's platform. After the shopping cart is received back in the customer's procurement system, the customer performs administrative actions within the procurement system to send the cart for approval to their supervisor, who approves the cart. After approval, the procurement system sends a purchase order to the supplier system.

### BRIEF DESCRIPTION OF THE DRAWINGS

FIG. 1 is a system diagram, according to a first embodiment, for ordering products directly through a supplier website.

FIG. 2 is a flow diagram for using the system of FIG. 1

FIG. 3 is a system diagram, according to another embodiment, for ordering products directly through a supplier website.

FIG. 4 is a flow diagram according to yet another embodiment for ordering products through a supplier website using the system of FIG. 1 or 3.

FIG. 5 is a flow diagram according to another embodiment for ordering products through a supplier website using the system of FIG. 1 or 3.

FIG. 6 depicts a generalized example of a suitable computing environment in which the described innovations may be implemented.

### DETAILED DESCRIPTION

A system is disclosed allowing a customer to directly build a shopping cart(s) on a supplier's portal (such as website, applications) without initiating any shopping request from company's network or system (such as eProcurement system). Various authentication and authorization mechanisms are used for secured data exchange and push/pull models are used to allow the customer system to receive the content of pre created shopping cart(s). After the user (part of one or more customer accounts) logs into the supplier's portal, the user can be identified as associated with the third-party system. In such a case, the user is displayed a control allowing the shopping cart to be transmitted to the third-party customer system (user can choose customer account in case of multiple) for further administrative processes (such as auditing, approval, policies, etc).

A system is proposed that enables a business customer (typically an employee of a third party) to add items to a list of products (e.g. build a shopping cart) without initiating a shopping session from their company's eProcurement system. Prior systems required customers to login to their own third-party system in order to buy products from a supplier (i.e., an E-commerce website), which can be limiting if the customer is on a mobile device or away from a typical office environment. The disclosed system allows the customer to log directly onto the supplier website and offers various modes of operation, such as a synchronous (Online) mode and asynchronous (Offline) mode for the third-party system to retrieve the items in the shopping cart. In either mode, the supplier maintains the customer's cart and transmits the data as needed. In a synchronous push mode, the supplier pushes the customer's shopping cart back to the third-party system (e.g., an eProcurement system for B2B e-commerce). In the asynchronous pull mode, the third-system retrieves the shopping cart through APIs. Thus, shopping carts are produced online on the supplier's website and pushed/pulled in any format (e.g., XML, JSON, EDI, CSV or any API-defined formats) to the third-party system.

Thus, the customer can search, browse, compare, and buy products from an eCommerce website associated with the supplier without using any controlled environment of customer's eProcurement system. The system integrates an eProcurement platform and the eCommerce website, which allows shopping and ordering data to flow seamlessly therebetween. The customer configures the eProcurement connection details on the supplier's website, which controls the flow of how product information is received by the third-party system. A business customer with a third-party eProcurement system provides the supplier certain system integration details, such as a URL, where the shopping cart details are to be sent, how employees of the business customer are to be identified (e.g. e-mail, cookie, authentication token, etc.) and how the eProcurement system identifies the supplier system (e.g. authentication token, SSO, etc.) Once a cart is created by a customer, the customer selects a control that causes the supplier system to transmit cart details and a user identification back to the third-party eProcurement system for review and/or approval. In another embodiment, the third-party eProcurement system periodically requests carts created by its employees from the supplier system using the previously agreed authentication protocol.

Thus, the customer need not to be in the third-party eProcurement application network to create a shopping session on the supplier network. Additionally, the buyer can utilize a Mobile Shopping Application for enterprise buying. Finally, the buyer can obtain an end-to-end eCommerce-website experience for enterprise buying.

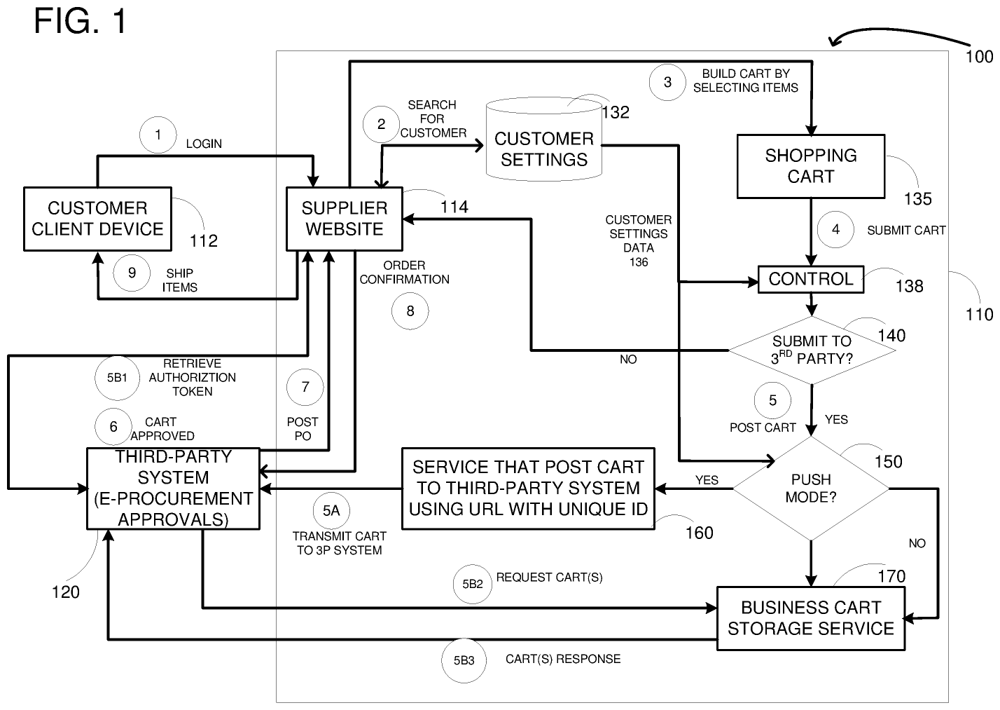

FIG. 1 shows a first embodiment of a system 100 for ordering products directly through a supplier network 110. A customer operating a client device 112 accesses a supplier website 114 of the supplier system 110. The supplier website 114 is an online marketplace allowing consumers and businesses to purchase products using ecommerce. The supplier website 114 is typically executing on a plurality of server computers within the supplier network 110. The customer is an employee of a third-party system 120 that requires approvals of purchases made by the customer on behalf of the business. The third-party system is any business that desires purchasing goods from the supplier system 110 in a B2B eCommerce context. More generally, the third-party system can be an eProcurement system or any system that performs ecommerce activity. The client device 112 can be any client device, such as a mobile phone, tablet, laptop computer, etc. Notably, the customer operating the client device 112 does not login to the third-party system 120 and access the supplier system 110 through the third-party system. Instead, the customer operating the client device 112 logs directly into the supplier web site 114. The supplier system 110 further includes a database 132 for storing customer settings. For example, an administrator of the third-party system 120 configures a customer business account for enabling purchasing directly (i.e., without logging into the third-party system) from the supplier system 110. The administrator further provides an identification strategy allowing the supplier system 110 to identify the customer 112 as associated with the third-party system 120. Example, identification strategies include using a user-specific unique identifier (Email ID, Mobile Number, third-party common keys, cookie, token, etc.), SSO details or Third-Party authentication and authorization. Other configurations can include defining whether a push or pull model is used for supplying a shopping cart to the third-party system 120, providing a URL in the third-party system 120 where to push the shopping cart details, providing an authentication technique to be used for communications between a supplier system 10 and the third-party system, etc. Other configurations can be used. In order to configure the customer settings 132, the third-party system 120 can submit the settings through an API to the supplier website 114. The supplier website 114 can then populate the customer settings in the database 132.

In order to further understand interactions between the customer client device 112, the third-party system 120 and the supplier system 110, circled numbers are indicated relating to example steps that can occur. At 1, a customer using the customer client device 112 logs directly into a supplier website 114 to purchase goods, just the same as a general consumer (unaffiliated with the third-party system) logs into the supplier website 114. The customer login is typically using credentials associated with a business account. At 2, the supplier website 114 searches the customer login details in the database 132, such as by searching using a parameter of the credentials as a key (e.g., an email address). If a match is found, then the supplier website 114 identifies the customer as associated with the third-party system. Other business account details and setup properties are also retrieved from the database 132. At 3, the customer creates a shopping cart 135 on the supplier website 114, such as by placing one or more products in a shopping cart for purchase. The shopping cart is software that includes identifiers associated with products to purchase. At 4, the customer submits the shopping cart 135 for purchase and the supplier system 110 checks the previously retrieved properties (shown as customer settings data 136). If the customer is associated with the third-party system, then a control (UI element or button) 138 is displayed. The control asks the customer whether to submit the cart to the third-party system 120 for approval of the purchases. Decision block 140 uses a result of the customer's selection of the control 138 to determine whether the customer wants to submit the cart for approval to the third-party system. If not, then the customer returns to the supplier website 114 to continue shopping. If the customer chooses to submit the shopping cart to the third-party system 120 through selection of the control, then at 5, the shopping cart is posted. Then, at decision 150, the retrieved properties 136 are used to determine whether a push mode or a pull mode is to be implemented in accordance with the setup.

In a push mode, as shown at 5A, a service 160 is used that posts the products of the shopping cart to a URL found within the customer's settings data 136. The service 160 is executing on one or more server computers within the supplier system 110. The service 160 uses the shopping cart data from current session to create a Punchout Order Message (POOM) content, and then adds the identification strategy from the customer settings data 136 as meta data in the POOM. The POOM includes the shopping cart items (including a unique product identifier for each product) that the customer checked out from the eCommerce site 114. Finally, the POOM content is posted to the URL (customer third-party system receiving site). Thus, in one embodiment, a list of product identifiers and other information (e.g., a user identification parameter) associated with the shopping cart can be transmitted to the third-party system. In the case of SSO, the service 160 can establish an SSO connection with the third-party system 120 and supply information associated with the shopping cart to the URL. The URL can be configured in numerous ways. In one example, a static configuration is used. In this case, the supplier system 110 posts the shopping cart contents back to the same URL for all the cart requests. In another example, a dynamic configuration is used. In this case, a customer can use dynamic parameters, such as a customer specific rotation key in a query string. The supplier may prefer to use secure URLs (https:) as it means that there is an encrypted connection between the customer system and the supplier system. The secure URL has parameters and placeholders to confirm the security of URL.

If decision 150 is answered in the negative, then the system is configured for a pull mode of operation (Offline Cart Transfer). At 5B1, the third-party system 120 calls the supplier website 114 using an API to retrieve an authentication token. At 5B2, the third-party system uses APIs and the authentication token along with cart filters (identifiers (e.g., a cookie, email address, or token), user, name, etc.) to obtain the cart data from a business cart storage service 170 executing on one or more server computers in the supplier system 110. The service 170 returns the desired cart or carts at 5B3. The pull model allows the third-party service to apply filters associated with the available carts, such as pulling all carts associated with an event or a person. Additionally, the pull is asynchronous and occurs whenever the third-party system chooses to do so.

Whether push mode or pull mode is used, the cart is received by the third-party system 120, that passes through an approval procedure, which can be automated, manual, or a combination of the two. At 6, the cart is approved, meaning one or more products in the cart are approved for purchase from the supplier system 110. The approval of the cart can be a partial approval (some of the products), a full approval (all products approved), or a rejection of the cart. Approval of the cart includes reviewing the products in the cart and determining whether the items comply with or violate internal business policies of the third-party system 120. For example, a business might allow office supplies, but not allow alcohol. At 7, a purchase order (PO) is transmitted or otherwise posted to the supplier website 114. For approved items in the cart, the third-party system generates a PO according to regular business practices between the supplier website and the third-party system. At 8, the order is confirmed indicating that it has been accepted for shipment. At 9, the items are shipped either to the customer 112 or to the third-party system 120.

As will be appreciated, in some embodiments, the system 110 may omit the control so that any completed shopping cart computed by the user that is recognized by the system as being associated with a third-party system 120 is automatically sent by the service 150 back to the third-party system for review and/or approval.

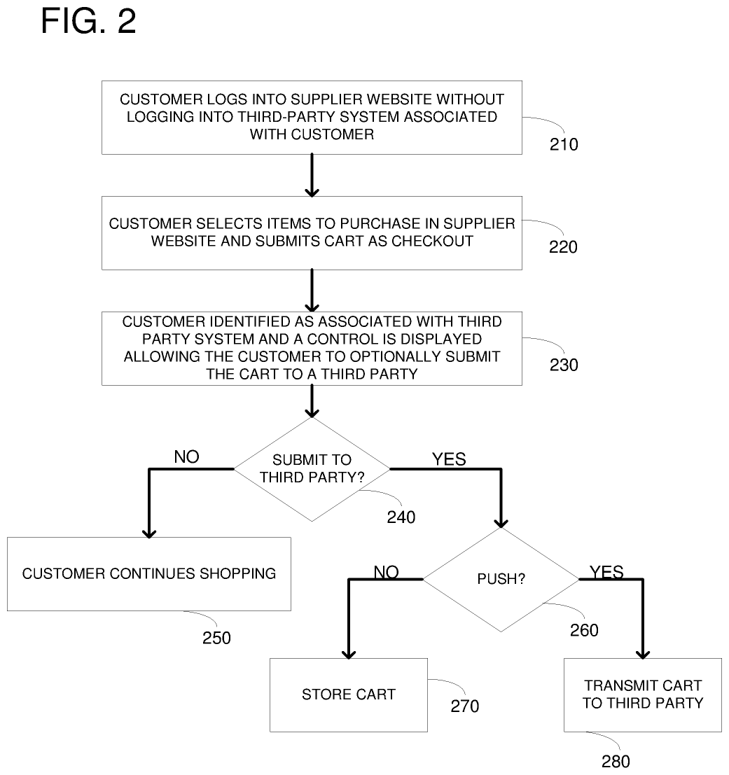

FIG. 2 is a flowchart according to one embodiment for purchasing products on a supplier website. In process block 210, a customer logs into a supplier website without logging into a third-party system associated with the customer. For example, in FIG. 1, the customer client device 112 directly logs in to the supplier website 114 instead of logging into the third-party system 120 and accessing the supplier website 114 via the third-party system. In process block 220, the customer selects items to purchase in the supplier website (which are placed in a shopping cart) and submits the cart at checkout. Thus, in FIG. 1, the customer builds the shopping cart 135 by selecting items to purchase and adding them to the shopping cart. The shopping cart 135 thereby includes a list of products, each of which is associated with a unique identifier. The user can then select an option to checkout. At process block 230, the customer is identified as associated with the third-party system and a control (shown as item 138) is displayed allowing the customer to optionally submit the cart to the third-party system. In decision block 240, if the customer selected to not submit the cart, then the customer continues shopping (process block 250). If the customer selects to submit the cart, then at decision block 260, the customer settings data 136 is checked to determine whether a push or pull mode of operation is being used. If a push mode is being used, then at process block 280, the cart is transmitted to the third party as described above. For example, the product identifiers and other related information can be posted to a URL identified in the customer settings data 136. If a pull mode of operation is used, then the product identifiers are stored at process block 270 in a business cart storage service 170. The third-party system can then use a token to retrieve the cart associated with the customer. In one example, the third-party system can use an API call with parameters including an identifier of the customer. The supplier system can authenticate the third-party system using the token and search for carts that match the identifier. Once the cart is identified, the product identifiers in the cart are transmitted to the third-party system.

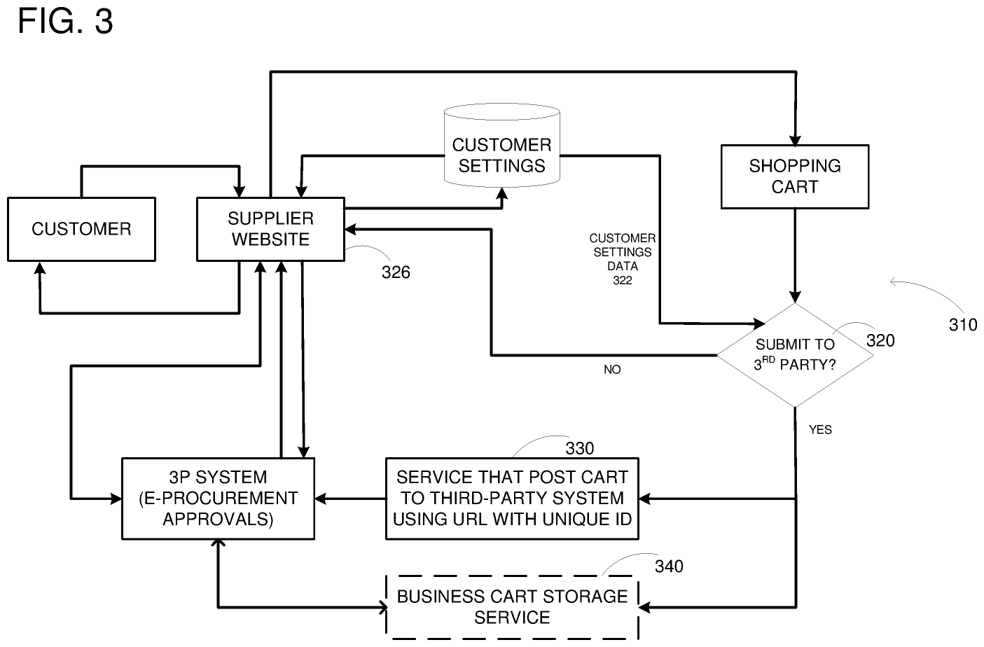

FIG. 3 is another embodiment for purchasing products from a supplier website 310. In this embodiment, the control 138 from FIG. 1 is not used. Instead, when the customer submits the shopping cart, at decision block 320, only the customer settings data 322 is used to determine whether the customer continues shopping with the supplier website 326 or posts the cart to a service 330, which results in a push mode of operation, similar to the push mode described above. In an alternative, the customer settings data 322 is analyzed to determine whether to submit the cart to a business cart storage service 340 for a pull mode of operation, similar to the pull mode described above. Other than the control not being displayed, the operation of the system 310 is similar to the operation of the system 110, described above, and is not re-described for simplicity.

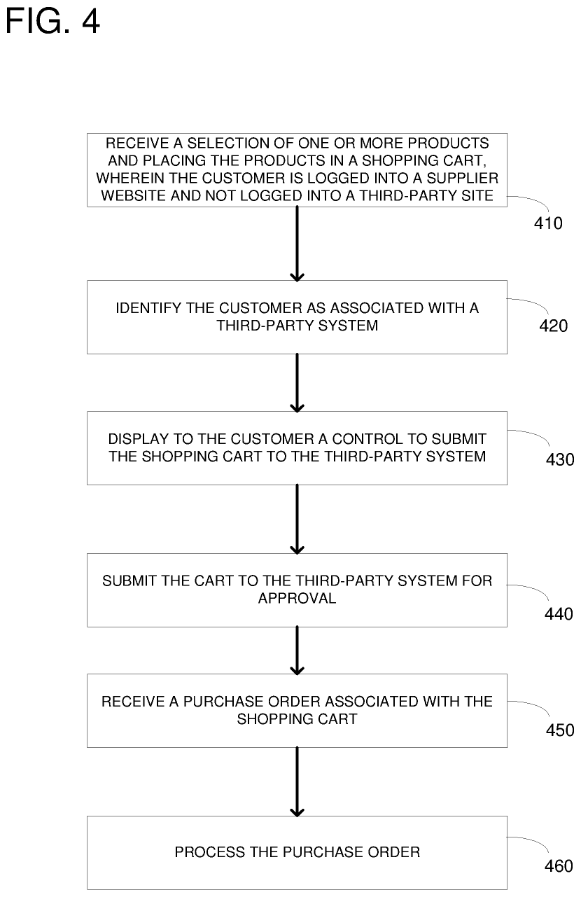

FIG. 4 is a flowchart according to another embodiment. In process block 410, a selection is received of one or more products in a shopping cart from a customer that is logged into the supplier website without being logged into their company's website (a third-party site) for accessing the supplier website. In process block 420, the customer is identified as associated with the third-party system. For example, the customer's login credentials are used to search the customer settings database 132. If a match is found, then the customer is automatically associated with the third-party system 120, which needs to approve any purchases by the customer. In process block 430, a control (e.g., 138 in FIG. 1) is displayed to the customer asking whether to submit the shopping cart to the third-party system. In process block 440, assuming the customer selected the control to submit the cart, the cart is submitted to the third-party system for approval. Such a submission can be accomplished by posting the product identifiers and other associated metadata to a URL in the customer settings data 136 stored in the database 132. In process block 450, a purchase order is received by the supplier system indicating that the shopping cart items that were approved by the third-party system. In process block 460, the purchase order is processed by the supplier system. As a result, the products are shipped to the third-party system.

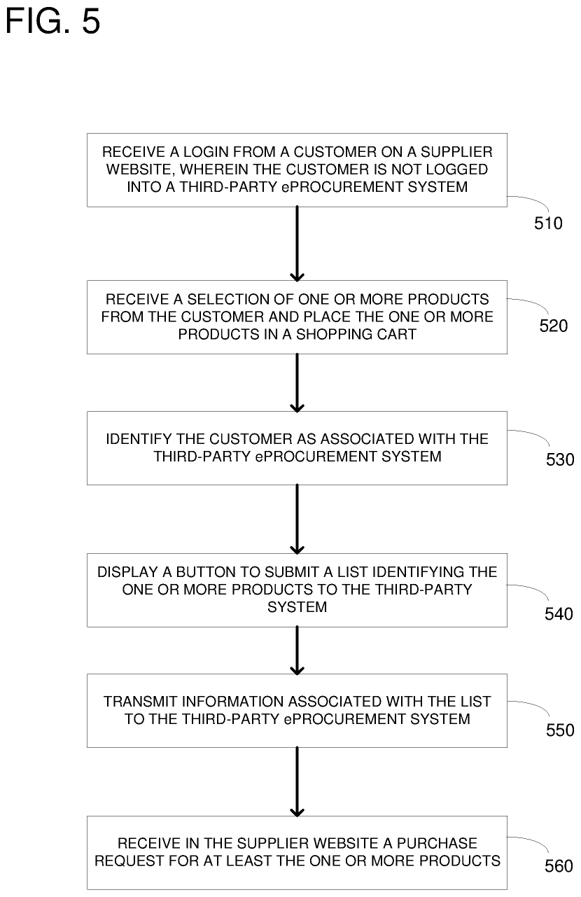

FIG. 5 is a flowchart according to another embodiment. In process block 510, a login is received from a customer in a supplier website, wherein the customer does not enter the supplier website through a third-party eProcurement system. In process block 520, the customer selects one or more products and places the products in an electronic shopping cart. In process block 530, the customer is identified as being associated (e.g., an employee) with the third-party eProcurement system. Such an identification can occur by using the customer identifier from the login credentials and using it to search a database (see FIG. 1 at 132). In process block 540, a button or other control is displayed asking the customer whether to submit the cart to the third-party system. In some embodiments, the control (and process block 540) can be omitted. Assuming the customer selects the control, a list identifying the products selected is transmitted to the third-party eProcurement system (process block 550). Finally, at process block 560, the supplier website receives a purchase request indicating approval for the customer to purchase one or more of the products on the list. The supplier can then fulfill the purchase order.

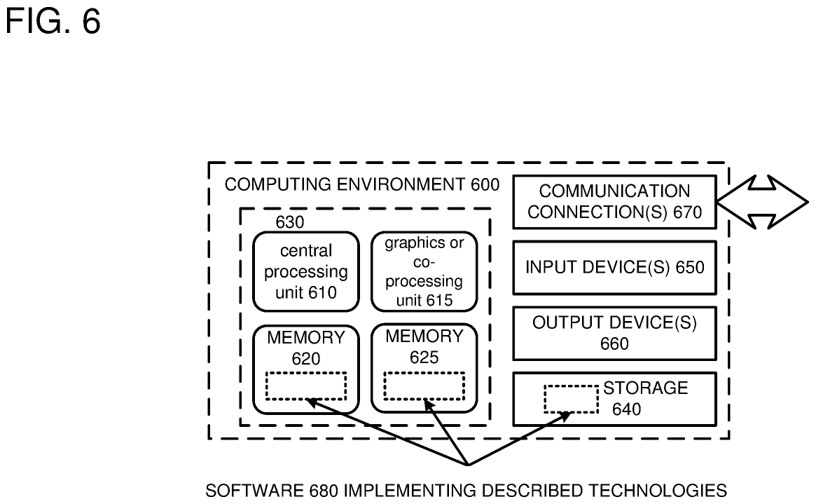

FIG. 6 depicts a generalized example of a suitable computing environment 600 in which the described innovations may be implemented. The computing environment 600 is not intended to suggest any limitation as to scope of use or functionality, as the innovations may be implemented in diverse general-purpose or special-purpose computing systems. For example, the computing environment 600 can be any of a variety of computing devices (e.g., desktop computer, laptop computer, server computer, tablet computer, etc.). FIG. 6 can be used as any of the eCommerce website, the third-party procurement system, or the customer.

With reference to FIG. 6, the computing environment 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s).

A computing system may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The tangible storage 640 may be removable or non-removable, and includes magnetic disks, magnetic tapes or cassettes, CD-ROMs, DVDs, or any other medium which can be used to store information in a non-transitory way and which can be accessed within the computing environment 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing environment 600. The output device(s) 660 may be a display, printer, speaker, CD-writer, or another device that provides output from the computing environment 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASIC s), Program-specific Standard Products (AS SPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only examples of the invention and should not be taken as limiting the scope of the invention. We therefore claim as our invention all that comes within the scope of these claims.

What is claimed is:

1. A method of purchasing products on a supplier website for a business, the method comprising:
receiving a login from a customer on the supplier website without accessing a third-party eProcurement system;
receiving a selection of one or more products from the customer for purchase and placing the one or more products in a shopping cart;
identifying the customer as associated with a third-party eProcurement system requiring review for purchases;
displaying, to the customer, a button to submit a list identifying the one or more products in the shopping cart to the third-party system;
transmitting information associated with the list from the supplier website to the third-party eProcurement system, wherein the information includes the list and a user identification parameter associated with the customer; and
receiving in the supplier website from the third-party eProcurement system that a purchase request for at least one of the one or more products in the shopping cart.

2. The method of claim 1, wherein the transmitting information includes pushing the information from the supplier website to the third-party eProcurement system.

3. The method of claim 1, wherein the transmitting information includes transmitting the information from the supplier website in response to a pull request.

4. The method of claim 1, wherein the user identification parameter includes one or more of the following that uniquely identifies the customer: a cookie, an email address, or a token.

5. The method of claim 1, further including transmitting to the third-party eProcurement system a token for extracting information for one or more shopping carts.

6. A method, comprising:
receiving a selection of one or more products in a shopping cart from a customer logged into a supplier website, wherein the customer is not logged into a third-party system for which the one or more products are being purchased;
identifying the customer as associated with a third-party system;
displaying to the customer a control to submit the shopping cart to the third-party system for review;
submitting the shopping cart to the third-party system for approval;
receiving a purchase order associated with the shopping cart; and
processing the purchase order.

7. The method of claim 6, wherein the third-party system is an eProcurement system or a system that performs ecommerce activity.

8. The method of claim 6, further including determining whether the customer is logged in as a business account and retrieving properties associated with customer.

9. The method of claim 8, wherein the properties include optionally pushing information associated with the shopping cart to the third-party system or storing the information for the third-party system to pull the stored information.

10. The method of claim 6, further including transmitting information associated with the shopping cart from the supplier website to the third-party system, wherein the information authenticates a supplier of the supplier website and user identification parameters associated with the customer.

11. The method of claim 6, further including receiving from the third-party system that the shopping cart is approved.

12. The method of claim 6, further including transmitting an authentication token to the third-party system enabling the third-party system to pull information associated with the shopping cart from the supplier website.

13. The method of claim 12, further including receiving the authentication token from the third-party eProcurement system at the supplier website and transmitting information relating to the shopping cart to the third-party system.

14. The method of claim 6, further including retrieving a URL indicating where to transmit information associated with the shopping cart.

15. One or more non-transitory computer-readable storage media storing computer-executable instructions for causing a computing system to perform a method, the method comprising:
receiving a login request in a supplier website from a customer, without the customer being logged into a third-party system;
identifying the customer as being associated with the third-party system by comparing a customer identifier to stored identifiers in a database;
receiving a request to purchase products on the supplier website;
for the customer associated with the third-party system, transmitting information associated with the products to the third-party system; and
receiving a purchase order from the third-party system for the products.

16. The one or more non-transitory computer-readable storage media of claim 15, wherein the method further comprises:
displaying, to the customer, a control to optionally transmit the information associated with the products to the third-party system.

17. The one or more non-transitory computer-readable storage media of claim 15, wherein the method further comprises:
reading the database to determine whether purchases associated with the customer are posted directly to the third-party system or whether the third-party system pulls the purchases from the supplier website.

18. The one or more non-transitory computer-readable storage media of claim 15, wherein the method further comprises:
receiving customer settings data for the customer from the third-party system and storing the customer settings data in the database.

19. The one or more non-transitory computer-readable storage media of claim 15, wherein the third-party system is an eProcurement system or a system that performs ecommerce activity.

20. The one or more non-transitory computer-readable storage media of claim 15, wherein the method further comprises:
transmitting an authentication token to the third-party system enabling the third-party system to pull information associated with the products from the supplier website.
